(19) United States
(12) Patent Application Publication
(10) Pub. No.: US 2006/0113508 A1
(43) Pub. Date: Jun. 1, 2006

(54) Liquid crystalline photoluminescent polarizers, devices and methods

(76) Inventors: Stephen M. Kelly, Beverley (GB); Mary O'Neill, Hull (GB); Gene C. Koch, Bayville, NJ (US)

Correspondence Address: Ronald D. Trice;PMB 138, 2101 Crystal Plaza Arcade, Arlington, VA, 22202-4600, US

(21) Appl. No.: 10/997,993

(22) Filed: Nov. 29, 2004

(51) Int. Cl. C09K 11/06

(52) U.S. Cl. 252/301.16

(57) ABSTRACT

A polymerizable mixture of an alignable photoluminescent reactive mesogen and a sensitizer may be polymerized to form an aligned photoluminescent film. The polymerization may be achieved through photopolymerization which also allows for photopatterning.

### FIELD OF THE INVENTION

The present invention relates generally to organic light emitting devices (OLEDs), methods of using OLEDs and method of making OLEDs, and more particularly, to (OLEDs) having a certain emitter, methods of using OLEDs having a certain emitter and method of making OLEDs having a certain emitter.

### BACKGROUND

Photoluminescent polarizers may be fabricated by the stretching or by otherwise elongating a photoluminescent polarizer film to align the emitter molecules. Unfortunately, these photoluminescent polarizer films may have a variation in the emitter molecule orientation and may have a relatively low polarization ratio for their emitted light. Furthermore, such stretched films are difficult to pattern. This makes such photoluminescent films neither cost effective nor consistently reproducible. Thus, such photoluminescent polarizer films are often poorly suited to many display applications such as high quality liquid crystal displays. Accordingly, there is a strong need in the art for photoluminescent polarizers that may be easily manufactured, have highly uniform, have high polarization ratios and easily patterned.

### SUMMARY OF THE INVENTION

An aspect of the present invention is to provide a polymerizable photoluminescent mixture including a polymerizable mixture of an alignable photoluminescent reactive mesogen and a sensitizer.

Another aspect of the invention is to provide a photoluminescent polymer including a polymer formed from alignable photoluminescent reactive mesogens and from sensitizers.

Another aspect of the invention is to provide a method of forming a photoluminescent polymer including depositing a polymerizable mixture of an alignable photoluminescent reactive mesogen and a sensitizer on a surface, and polymerizing the polymerizable mixture.

### BRIEF DESCRIPTION OF THE DRAWINGS

The invention will be described in detail with reference to the following drawing:

FIG. 1 illustrates a wavelength selective reflector on the light source side of a photoluminescent polarizer.

### DETAILED DESCRIPTION

Emissive materials with very high polarization ratios may be achieved by polymerizing reactive mesogens that have a sufficiently high anisotropy of emission and are sufficiently aligned (e.g., liquid crystalline). For example, isotropically absorbing and emitting sensitizers may be dissolved in solutions of photoluminescent reactive mesogens that are solvent cast and then photocrosslinked to form the photoluminescent films. The reactive mesogen films may be aligned by coating the photoluminescent film on the surface of a film of rubbed polymer such as polyimide, on the surface of a photoalignment layer or any other suitable alignment means. For example, photoalignment layers such as are described in M. O'Neill and S. M. Kelly, J. Phys. D Appl. Phys. [2000], 33, R67 or surface topology may also be used to align a photoluminescent film. After an aligned photoluminescent film has been photocrosslinked, the aligned photoluminescent film functions as photoluminescent polarizer film.

Because the otherwise solvent soluble photoluminescent polarizer film is locked into place by photocrosslinking, the aligned photoluminescent film may be patterned by a photolithographic process. If alignment is achieved with a photoalignment layer, areas of varying alignment direction may be patterned by successive exposures to light with varying polarization directions through a series of photomasks. Alternatively, a single exposure with varying polarization directions may be performed. Thus arrays of polarizer “pixels” may be produced with alternating colors and/or polarization directions.

One approach to achieving highly anisotropic and well aligned liquid crystal molecules is to increase the length of the emitter molecules so that the length to width ratio of the molecules is maximized. Unfortunately, the longer and more rigid molecules cause the melting point to increase and/or decrease the solubility. Thus, molecules that were sufficiently long to achieve desirable polarization ratios (e.g., in the range of 20:1) had such a high melting point and/or were so insoluble that coating a useful reactive mesogen film to be polymerized was extremely difficult if not impossible.

However, certain materials, such as reactive mesogens with very long molecular lengths with the general formula:
B—S-A-S—B
wherein

A is a chromophore of general formula —(Ar—Fl)ₙ—Ar—

wherein
Ar is an aromatic diradical or a heteroaromatic diradical bonded linearly or substantially linearly to adjoining diradicals, or a single bond;
Fl is a 9,9-dialkyl substituted fluorene diradical joined to adjoining diradicals at the 2 and 7 positions;
the Ar and Fl diradicals may be chosen independently in each of the n subunits of the chromophore; and
1≦n≦10, but preferably 3≦n≦10;
S is flexible spacer; and
B is an endgroup that is susceptible to radical photopolymerization, for example, 1,4-pentadiene-3-yl, methacryloyl, or arcryloyl, have been developed that allow long backbones while at the same time maintaining relatively low melting points and reasonable solubilities in common solvents. The above materials are further discussed in U.S. patent application Ser. No. 10/858,507, which is incorporated herein in its entirety by this reference.

One example of the above materials is the below compound: 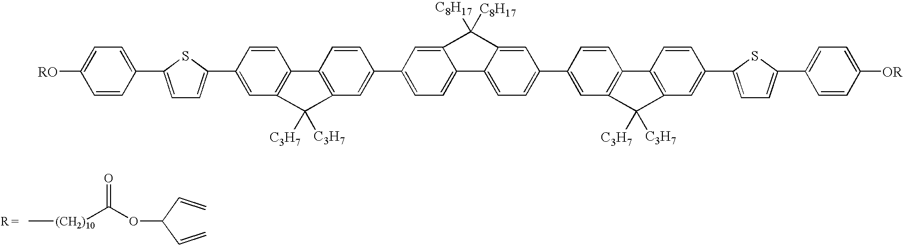
which has a melting point of 80° C., a monotropic nematic to isotropic liquid phase transition at 39° C. and has good solubility in solvents like dichloromethane.

Prior to polymerization, sensitizer chromophores may be introduced into the above reactive mesogens. The sensitizer chromophores absorb excitation light of all polarizations and then transfer the excitation energy to the reactive mesogen for re-emission as polarized light. The sensitizer chromophores may be in the form of individual luminescent molecules. For example,

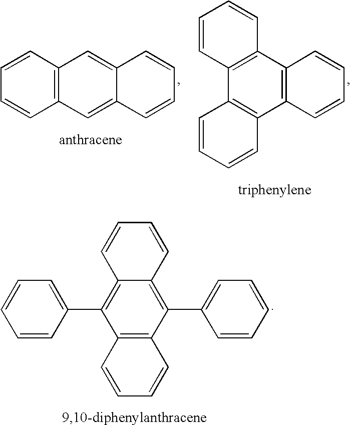

If the above reactive mesogens and sensitizer is to be patterned photolithographically, the sensitizer molecules may be washed out of the polymer matrix on development of the exposed material. This problem may be avoided by using fluorescent molecules derivatized with an endgroup that is susceptible to radical photopolymerization as sensitizers in the photoluminescent polarizer film. Exemplary crosslinkable sensitizer materials of this type may have the formula:
D(—S—B)ₙ

wherein
D is the sensitizer chromophore,
S is a flexible spacer, B is an endgroup susceptible to radical photopolymerization, and
n=1 to 10.

For example, the following materials: 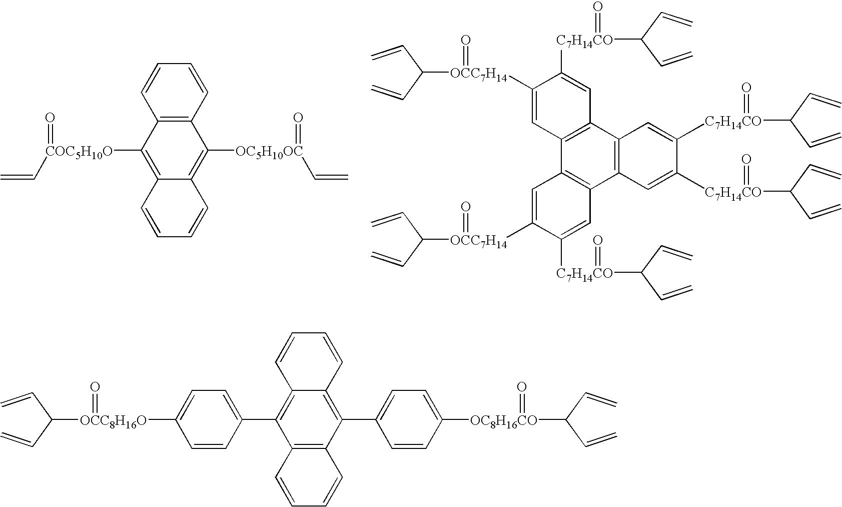
may be used as sensitizers.

Another issue with mixing the above photoinitiator molecules into reactive mesogens and then polymerizing them to form photoluminescent polarizer films is that these sensitizer films are non-liquid crystalline and therefore they reduce the liquid crystal order of the resulting films. This in turn reduces the polarization ratio of light emitted from the films.

This problem may be minimized by incorporating the sensitizer chromophores into long rod-shaped molecules where the chromophores are isolated from other delocalized chemical structures so as to not alter their spectral characteristics or the symmetry of their light absorption. For example, this may be accomplished by using sigmatropically bonded structures to bind the chromophoric units into the molecules.

One such sensitizer molecule family may be represented by the formula:
B—S—Ar—Sg-(D-Sg—Ar)ₙ—S—B

wherein
B represents an endgroup susceptible to radical photopolymerization;
S represents a flexible spacer;
each Ar may be independently selected from a aromatic or heteroaromatic diradical (e.g., a 9,9-dialkylfluoren-2,7-diyl diradical), or a single bond;
Sg represents a substantially rigid, sigmatropically bonded connecting diradical;
D represents a sensitizer chromophore; and
n=1 to 10.
   The diradicals that constitute the molecules are bonded together in a substantially linear fashion.

Another family of molecules of this type may in general be represented by the formula:
B—S-D-Sg—(Ar—Sg-D)ₙ—S—B

B represents an endgroup susceptible to radical photopolymerization;

S represents a flexible spacer;

each Ar may be independently selected from a aromatic or heteroaromatic diradical (e.g., a 9,9-dialkylfluoren-2,7-diyl diradical), or a single bond;

Sg represents a substantially rigid, sigmatropically bonded connecting diradical;

D represents a sensitizer chromophore; and

n=1 to 10. The diradicals that constitute the molecules are bonded together in a substantially linear fashion.

Some examples of molecules of the above types are:

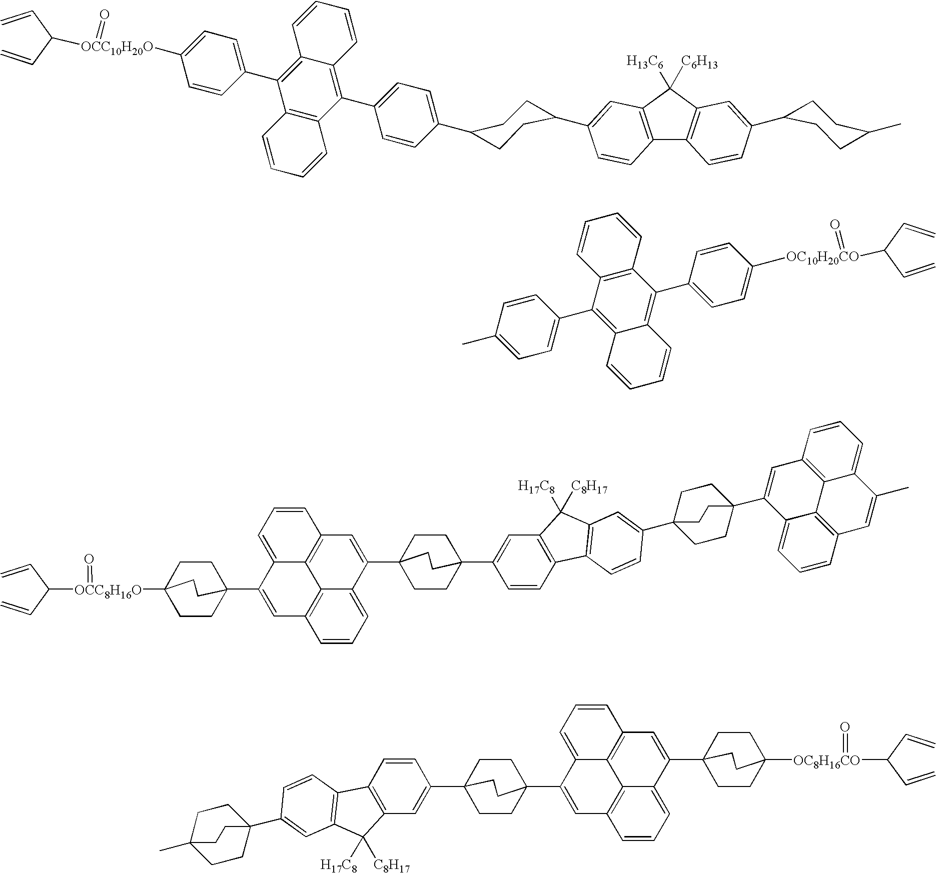

Sensitizer molecules advantageously adsorb equally regardless of polarization direction. Therefore the dichroic ratio of the sensitizer chromophores in the photoluminescent polarizer film preferably has a dichroic ratio that substantially equal 1:1. At maximum the dichroic ratio should be less than 3:1.

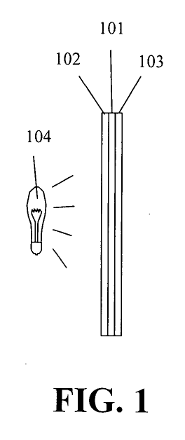

The above photoluminescent films may be stand alone films or may be incorporated into devices with other elements. For example, a wavelength selective reflector may be used on the light source side of a photoluminescent polarizer. This is illustrated in FIG. 1 which includes a reflector 102 that reflects photoluminance light emitted by a polarizer film 101 forward away from a light source 104 while transmitting light emanating from the light source 104 into the polarizer film 101 where it is absorbed by sensitizer chromophores. In some applications it also may be desirable to use a second wavelength selective reflector 103 on the side of the polarizer film 101 opposite the light source 104. This second wavelength selective reflector 103 reflects light wavelengths that are absorbed by the sensitizer or photoluminescent chromophores while transmitting light wavelengths emitted by the photoluminescent chromophores. The function of this second wavelength selective reflector 103 is to prevent inadvertent undesirable stimulation of photoluminescence light by absorption of ambient light in the polarizer film 101. The photoluminescent materials and films disclosed herein also may be used in various other devices.

Although several embodiments of the present invention and its advantages have been described in detail, it should be understood that changes, substitutions, transformations, modifications, variations, permutations, and alterations may be made therein without departing from the teachings of the present invention or the spirit and scope of the invention being set forth by the appended claims.

What is claimed is:

1. A polymerizable photoluminescent mixture comprising a polymerizable mixture of an alignable photoluminescent reactive mesogen and a sensitizer.

2. The mixture of claim 1, wherein the polymerizable mixture is a photopolymerizable mixture.

3. The mixture of claim 1, wherein the polymerizable mixture further comprises a non-luminescent reactive mesogen.

4. The mixture of claim 1, wherein the alignable photoluminescent reactive mesogen has the molecular formula:
B—S-A-S—B
wherein
B is an endgroup that is susceptible to photopolymerization,
S is a flexible spacer, and
A is a photoluminescent chromophore.

5. The mixture of claim 4, wherein the photopolymerization of the endgroup B is initiated by free radicals.

6. The mixture of claim 4, wherein the photoluminescent chromophore A has the formula:
—(Ar—Fl)ₙ—Ar—
wherein
Ar is an aromatic diradical, a heteroaromatic diradical bonded linearly or substantially linearly to adjoining diradicals, or a single bond;
Fl is a 9,9-dialkyl substituted fluorene diradical joined to adjoining diradicals at the 2 and 7 positions;
the Ar and Fl diradicals are independently selected in each of the n subunits of the chromophore; and
n=1 to 10.

7. The mixture of claim 4, wherein n=3 to 10.

8. The mixture of claim 6, wherein B comprises one of a 1,4-pentadien-3-yl radical, an acrylate, or a methacrylate.

9. The mixture of claim 1, wherein the sensitizer is a luminescent material whose emission spectra overlap the excitation spectra of the alignable photoluminescent reactive mesogen.

10. The mixture of claim 1, wherein the sensitizer has an absorption dichroic ratio of less than 3:1.

11. The mixture of claim 1, wherein the sensitizer is a polycyclic aromatic hydrocarbon.

12. The mixture of claim 1, wherein the sensitizer has the formula:
D(—S—B)ₙ
wherein
D is a sensitizer chromophore,
S is a flexible spacer,
B is an endgroup susceptible to radical photopolymerization, and
n=1 to 10.

13. The mixture of claim 1, wherein the sensitizer has the formula:
B—S—Ar₁—Sg-(D-Sg—Ar₂)ₙ—S—B
wherein
B is an endgroup susceptible to radical photopolymerization;
S represents a flexible spacer;
Ar₁ and Ar₂ are independently selected from a single bond or an aromatic or heteroaromatic diradical;
Sg represents a substantially rigid, sigmatropically bonded connecting diradical;
D represents a sensitizer chromophore; and
n=1 to 10.

14. The mixture of claim 13, wherein aromatic or heteroaromatic diradicals are bonded together in a substantially linear fashion.

15. The mixture of claim 13, wherein at least one of Ar₁ or Ar₂ is a 9,9-dialkylfluoren-2,7-diyl diradical.

16. The mixture of claim 1, wherein the sensitizer has the formula:
B—S-D-Sg—(Ar—Sg-D)ₙ—S—B
wherein
B represents an endgroup susceptible to radical photopolymerization;
S represents a flexible spacer;
Ar is independently selected from a single bond or an aromatic or heteroaromatic diradical;
Sg represents a substantially rigid, sigmatropically bonded connecting diradical; and
D represents a sensitizer chromophore; and
n=1 to 10.

17. The mixture of claim 16, wherein the Ar is a 9,9-dialkylfluoren-2,7-diyl diradical.

18. A photoluminescent polymer comprising a polymer formed from alignable photoluminescent reactive mesogens and from sensitizers.

19. The polymer of claim 18, wherein the polymer is a photopolymerized polymer.

20. The polymer of claim 18, wherein the polymer also formed from a non-luminescent reactive mesogen.

21. The polymer of claim 18, wherein the alignable photoluminescent reactive mesogen has the molecular formula:
B—S-A-S—B
wherein
B is an endgroup that is susceptible to photopolymerization,
S is a flexible spacer, and
A is a photoluminescent chromophore.

22. The polymer of claim 21, wherein the photopolymerization of the endgroup B is initiated by free radicals.

23. The polymer of claim 21, wherein the photoluminescent chromophore A has the formula:
—(Ar—Fl)ₙ—Ar—
wherein
Ar is an aromatic diradical, a heteroaromatic diradical bonded linearly or substantially linearly to adjoining diradicals, or a single bond;
Fl is a 9,9-dialkyl substituted fluorene diradical joined to adjoining diradicals at the 2 and 7 positions;
the Ar and Fl diradicals are independently selected in each of the n subunits of the chromophore; and
n=1 to 10.

24. The polymer of claim 23, wherein n=3 to 10.

25. The polymer of claim 23, wherein B comprises one of a 1,4-pentadien-3-yl radical, an acrylate, or a methacrylate.

26. The polymer of claim 18, wherein the sensitizer is a luminescent material whose emission spectra overlap the excitation spectra of the alignable photoluminescent reactive mesogen.

27. The polymer of clain 18, wherein the sensitizer has an absorption dichroic ratio of less than 3:1.

28. The polymer of claim 18, wherein the sensitizer is a polycyclic aromatic hydrocarbon.

29. The polymer of claim 18, wherein the sensitizer has the formula:
D(—S—B)ₙ
wherein
D is a sensitizer chromophore,
S is a flexible spacer,
B is an endgroup susceptible to radical photopolymerization, and
n=1 to 10.

30. The polymer of claim 29, wherein the sensitizer has the formula:
B—S—Ar₁—Sg-(D-Sg—Ar₂)ᵣ—S—B
wherein
B is an endgroup susceptible to radical photopolymerization;
S represents a flexible spacer;
Ar₁ and Ar₂ are independently selected from a single bond or an aromatic or heteroaromatic diradical;
Sg represents a substantially rigid, sigmatropically bonded connecting diradical;
D represents a sensitizer chromophore; and
n=1 to 10.

31. The polymer of claim 30, wherein aromatic or heteroaromatic diradicals are bonded together in a substantially linear fashion.

32. The polymer of claim 30, wherein at least one of Ar₁ or Ar₂ is a 9,9-dialkylfluoren-2,7-diyl diradical.

33. The polymer of claim 18, wherein the sensitizer has the formula:
B—S-D-Sg—(Ar—Sg-D)ₙ—S—B
wherein
B represents an endgroup susceptible to radical photopolymerization;
S represents a flexible spacer;
Ar is independently selected from a single bond or an aromatic or heteroaromatic diradical;
Sg represents a substantially rigid, sigmatropically bonded connecting diradical; and
D represents a sensitizer chromophore; and
n=1 to 10.

34. The polymer of claim 33, wherein the Ar is a 9,9-dialkylfluoren-2,7-diyl diradical.

35. The polymer of claim 18, wherein the polymer is formed on an alignment layer that aligns the polymer.

36. The polymer of claim 35, wherein the alignment layer is a rubbed polymer.

37. The polymer of claim 35, wherein the alignment layer is rubbed polyimide.

38. The polymer of claim 35, wherein the alignment layer is a photoalignment layer.

39. The polymer of claim 18, wherein the polymer is subdivided.

40. The polymer of claim 39, wherein the polymer is subdivided by photopatterning.

41. The polymer of claim 18, wherein the polymer emits different wavelength bands in different areas of the polymer.

42. The polymer of claim 18, wherein the polymer emits different orientations of linear polarized light in different areas of the polymer.

43. The polymer of claim 18, further comprising a wavelength selective reflector.

44. The polymer of claim 43, wherein the wavelength selective reflector transmits light of wavelengths absorbed by the sensitizer chromophores and reflects light of wavelengths emitted by the one or more photoluminescent reactive mesogen chromophores.

45. The polymer of claim 43, wherein the wavelength selective reflector transmits light of wavelengths emitted by the one or more photoluminescent reactive mesogen chromophores and reflects light of wavelengths absorbed by the sensitizer chromophores.

46. The polymer of claim 43, wherein the wavelength selective reflector is adjacent to the surface of the polymer into which an excitation light enters.

47. The polymer of claim 43, wherein the wavelength selective reflector is adjacent to a surface of the polymer from which photoluminescently emitted light exits.

48. The polymer of claim 18, wherein the polymer is a photoluminescent polarizer.

49. A method of forming a photoluminescent polymer comprising:
depositing a polymerizable mixture of an alignable photoluminescent reactive mesogen and a sensitizer on a surface; and
polymerizing the polymerizable mixture.

50. The method of claim 49, wherein the polymerizing the polymerizable mixture is performed with light.

51. The method of claim 49, wherein the polymerizable mixture includes a non-luminescent reactive mesogen.

52. The method of claim 49, wherein the alignable photoluminescent reactive mesogen has the molecular formula:
B—S-A-S—B
wherein
B is an endgroup that is susceptible to photopolymerization,
S is a flexible spacer, and
A is a photoluminescent chromophore.

53. The method of claim 52, wherein the photopolymerization of the endgroup B is initiated by free radicals.

54. The method of claim 52, wherein the photoluminescent chromophore A has the formula:
—(Ar—Fl)ₙ—Ar—
wherein
Ar is an aromatic diradical, a heteroaromatic diradical bonded linearly or substantially linearly to adjoining diradicals, or a single bond;
Fl is a 9,9-dialkyl substituted fluorene diradical joined to adjoining diradicals at the 2 and 7 positions;
the Ar and Fl diradicals are independently selected in each of the n subunits of the chromophore; and
n=1 to 10.

55. The method of claim 54, wherein n=3 to 10.

56. The method of claim 52, wherein B comprises one of a 1,4-pentadien-3-yl radical, an acrylate, or a methacrylate.

57. The method of claim 49, wherein the sensitizer is a luminescent material whose emission spectra overlap the excitation spectra of the alignable photoluminescent reactive mesogen.

58. The method of claim 49, wherein the sensitizer has an absorption dichroic ratio of less than 3:1.

59. The method of claim 49, wherein the sensitizer is a polycyclic aromatic hydrocarbon.

60. The method of clain 49, wherein the sensitizer has the formula:
D(—S—B)ₙ
wherein
D is a sensitizer chromophore,
S is a flexible spacer,
B is an endgroup susceptible to radical photopolymerization, and
n=1 to 10.

61. The method of claim 60, wherein the sensitizer has the formula:
B—S—Ar₁—Sg-(D-Sg—Ar₂)ₙ—S—B
wherein
B is an endgroup susceptible to radical photopolymerization;
S represents a flexible spacer;
Ar₁ and Ar₂ are independently selected from a single bond or an aromatic or heteroaromatic diradical;
Sg represents a substantially rigid, sigmatropically bonded connecting diradical;
D represents a sensitizer chromophore; and
n=1 to 10.

62. The method of claim 61, wherein aromatic or heteroaromatic diradicals are bonded together in a substantially linear fashion.

63. The method of claim 61, wherein at least one of Ar₁ or Ar₂ is a 9,9-dialkylfluoren-2,7-diyl diradical.

64. The method of claim 49, wherein the sensitizer has the formula:
B—S-D-Sg—(Ar—Sg-D)ₙ—S—B
wherein
B represents an endgroup susceptible to radical photopolymerization;
S represents a flexible spacer;
Ar is independently selected from a single bond or an aromatic or heteroaromatic diradical;
Sg represents a substantially rigid, sigmatropically bonded connecting diradical; and
D represents a sensitizer chromophore; and
n=1 to 10.

65. The method of claim 64, wherein the Ar is a 9,9-dialkylfluoren-2,7-diyl diradical.

66. The method of claim 49, further comprising aligning the polymerizable mixture with an alignment layer.

67. The method of claim 66,
wherein the alignment layer is a polymer alignment layer; and
further comprising rubbing the polymer alignment layer.

68. The method of claim 66,
wherein the alignment layer is a polyimide alignment layer; and
further comprising rubbing the polyimide alignment layer.

69. The method of claim 66,
wherein the alignment layer is a photoalignment alignment layer; and
further comprising exposing the photoalignment alignment layer to light.

70. The method of claim 49, wherein the polymerizable mixture is subdivided.

71. The method of claim 70, wherein the polymerizable mixture is subdivided by photopatterning.

72. The method of claim 49, wherein different wavelength bands are emitted in different areas of the polymerizable mixture after polymerizing the polymerizable mixture.

73. The method of claim 49, wherein different orientations of linear polarized light are emitted in different areas of the polymerizable mixture after polymerizing the polymerizable mixture.

74. The method of claim 49, further comprising providing a wavelength selective reflector.

75. The method of claim 74, wherein the wavelength selective reflector transmits light of wavelengths absorbed by the sensitizer chromophores and reflects light of wavelengths emitted by the one or more photoluminescent reactive mesogen chromophores.

76. The method of claim 74, wherein the wavelength selective reflector transmits light of wavelengths emitted by the one or more photoluminescent reactive mesogen chromophores and reflects light of wavelengths absorbed by the sensitizer chromophores.

77. The method of claim 74, wherein the wavelength selective reflector is adjacent to the surface of the polymer into which an excitation light enters.

78. The method of claim 74, wherein the wavelength selective reflector is adjacent to a surface of the polymer from which photoluminescently emitted light exits.
